(19) United States
(12) Patent Application Publication
(10) Pub. No.: US 2006/0124681 A1
(43) Pub. Date: Jun. 15, 2006

(54) Tape dispenser

(76) Inventor: Yu-Gang Chen, Yongkang City (TW)

Correspondence Address: Yu-Gang CHEN, P.O. Box No. 6-57, Taipei, 235, TW

(21) Appl. No.: 11/340,440

(22) Filed: Jan. 27, 2006

Related U.S. Application Data
(63) Continuation-in-part of application No. 10/870,989, filed on Jun. 21, 2004.

(51) Int. Cl. B26F 3/02

(52) U.S. Cl. 225/93

(57) ABSTRACT

A tape dispenser includes a main seat and a movable member. The movable member is connected to the main seat and can move relatively to the main seat. A dragging member is located at an upper rim of the main seat and a first space is formed below the dragging member. A cutting edge is transversally located at a proper distance to the dragging member. The aforementioned dragging member is transversally crossed over at a proper height of the main seat, and a second space, which is not reaching to a bottom rim of the main seat, is formed from top to bottom, at two side rims of the main seat, between the dragging member and the cutting edge. Accordingly, the tape dispenser can be surrounding a tape roll for cutting the tape, and the preserved second space can facilitate pulling the tape.

### BACKGROUND OF THE INVENTION

a) Field of the Invention

The present invention relates to a tape dispenser, and more particular to a convenient tape dispenser which is surrounding a tape roll and can move on the tape roll while dragging the tape.

b) Description of the Prior Art

U.S. Pat. No. 2,284,807 discloses a tape dispenser, wherein, during the process of operation, the tape dispenser remains stationary at its original position and the peeled-off tape cannot drag the tape dispenser to move with it; that is, there is no sufficient clearance preserved between the tape dispenser and the tape roll, such that it will not be very smooth in dragging the tape. Furthermore, after performing the cutting operation by the tape dispenser, there is not dragging end preserved for facilitating the next operation, which will not be convenient and will usually require some effort to find out the tape end for the next usage. U.S. Pat. No. 3,904,095 discloses another tape dispenser including two U-shape members being assembled and surrounding the tape roll, wherein the cutting edge is facing the tape, such that the peeled-off tape cannot drag the tape dispenser to move with it, either. In addition, after performing the cutting operation by the tape dispenser, there is either no dragging end preserved for the next operation. U.S. Pat. No. 4,405,068 also discloses a tape dispenser which surrounds the tape roll, wherein the cutting edge is facing the tape. Similarly, there is either no dragging end preserved for the next operation, after performing the cutting operation by the tape dispenser. The tape dispenser disclosed in U.S. Pat. No. 5,634,580 is not surrounding but is clipped on the tape roll which is provided with the tooth-like members 30 to abut the tape roll. The invention is also installed with a window-like opening 18, which can allow the tape to pass therein for dragging. However, during dragging, the tape dispenser is hard to move freely on the tape roll due to the resistance of the tooth-like members 30; that is, the tape dispenser cannot be smoothly dragged by the peeled-off tape, and can be even separated from the tape roll. Moreover, in FIG. 6 of the invention, although the tape is lifted up a little for facilitating the next dragging after performing the cutting operation, the height to be lifted is very limited, such that it will not be easy to put a finger into the clearance between the tape and the tape dispenser. U.S. Pat. No. 2,734,575 discloses a simple tape dispenser, wherein the peeled-off tape cannot drag the tape dispenser to move with it, and there is no dragging end preserved for facilitating the next operation, after performing the cutting operation by the tape dispenser.

### SUMMARY OF THE INVENTION

The primary object of present invention is to solve a problem that a tape dispenser will not be able to move smoothly with dragging, during an operation of the tape dispenser which is surrounding the tape.

Another object of the present invention is to solve a problem that there is no dragging end preserved for a next usage after performing a cutting operation by a tape dispenser which is surrounding the tape.

The present invention includes a main seat and a movable member. The movable member is connected to the main seat and can move relatively to the main seat. A dragging member is installed on an upper rim of the main seat, and a first space is formed below the dragging member. A cutting edge is transversally located at a proper distance to the dragging member. The aforementioned dragging member is transversally crossed over at a proper height of the main seat, and a second space, which is not reaching to a bottom rim of the main seat, is formed from top to bottom, between the dragging member and the cutting edge, at two side rims of the main seat.

The aforementioned first space below the dragging member is installed with a supporting member positioned into the first space, with a clearance preserved between the supporting member and the dragging member.

The present invention is provided with the following advantages:
1. The main seat and the movable member are both surrounding a tape roll, with a clearance between the tape roll. Therefore, in dragging the tape, the tape dispenser can move freely on the tape roll following a dragging direction of the tape, without interfering with the dragging of tape at all.
2. There is a sufficient space preserved at two side rims of the main seat, which can enable fingers to smoothly manipulate in the space to grip and pull the tape left behind from a previous cutting.
3. After cutting the tape, a residual section of the tape will be lifted up by the cutting edge to facilitate a next dragging.
4. For an embodiment which is provided with the supporting member, after cutting the tape, a residual section of the tape will be lifted up by the cutting edge and the supporting member, which will facilitate a next dragging, in association with the preserved space at two side rims of the main seat.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of an embodient of the present invention.

FIG. 2 shows a schematic view of an embodient which surrounds a circumference of tape roll of the present invention.

FIG. 3 shows a schematic view of an embodient of the present invention in cutting a tape.

FIG. 4 shows a schematic view of an embodient of the present invention after accomplishing a cutting.

FIG. 5 shows a perspective view of an embodient of the present invention installed with a supporting member.

FIG. 6 shows a schematic view of an application of embodient of the present invention which is installed with a supporting member and is used on a tape roll.

### DETAILED DESCRIPTION OF THE PREFERRED EMBODIMENTS

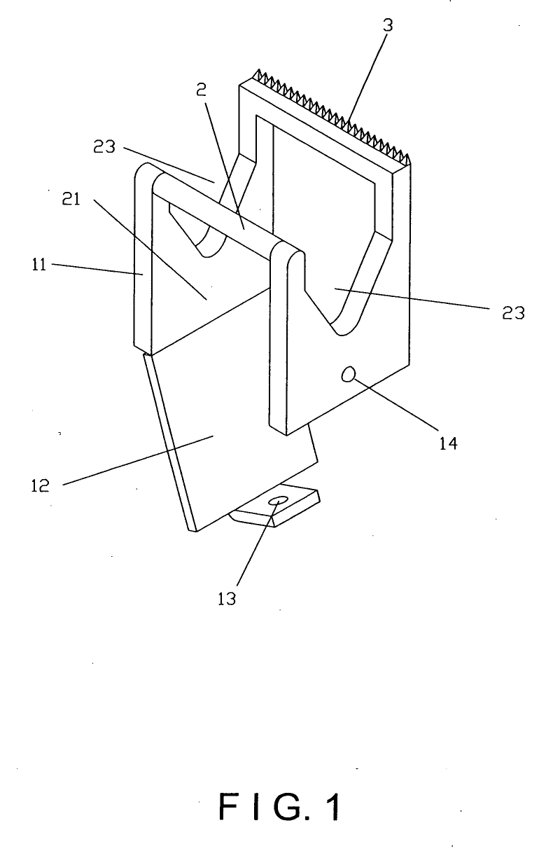

Referring to FIG. 1, an embodient of the present invention is composed of a main seat 11 and a movable member 12, wherein the main seat 11 and the movable member 12 are interconnected, a space of two sides of an inner rim of the main seat 11 is a little wider than a width of tape, a first assembly part 13 is located at a non-connection end of the movable member 12, and a first corresponding part 14 is located on the main seat 11 for corresponding to the first assembly part 13, such that the two seats are assembled with each other through the first assembly part 13 and the first corresponding part 14. The first assembly part 13 and the first corresponding part 14 are assembled with a latch, a magnetic force, an adhesive, and an elastic material; whereas the latching method is applied in the present embodient. A dragging member 2 is located at an upper rim of the main seat 11, and is transversally crossed over at a proper height above the main seat 11, so as to form a first space 21 below the dragging member 2. A cutting edge 3 is transversally crossed over on an upper rim of the main seat 11, at a proper height of the other side corresponding to the dragging member 2. In addition, a second space 33, which is not reaching to a bottom rim of the main seat 11, is formed from top to bottom, at two side rims of the main seat 11, between the dragging member 2 and the cutting edge 3.

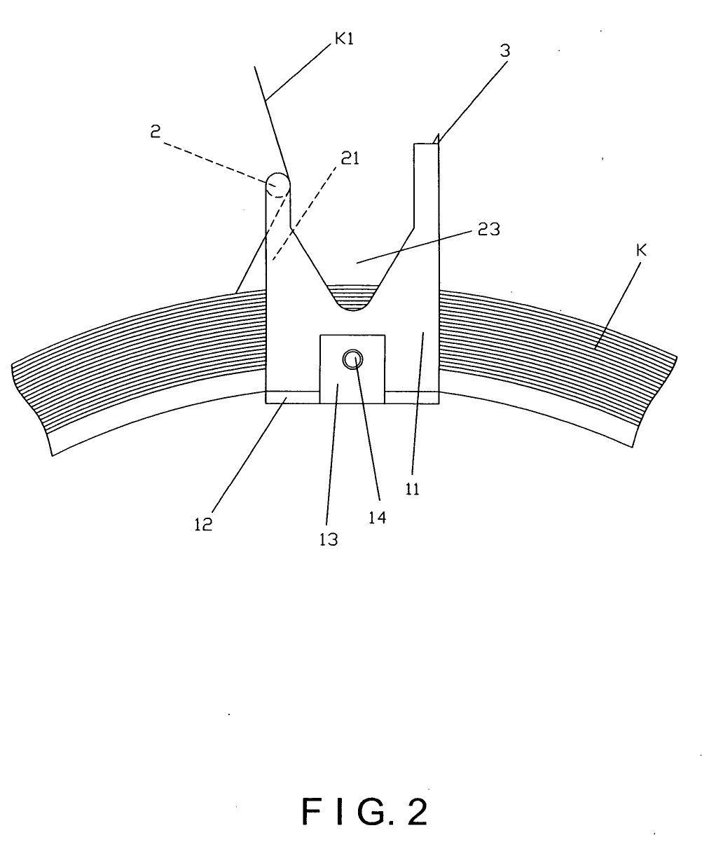

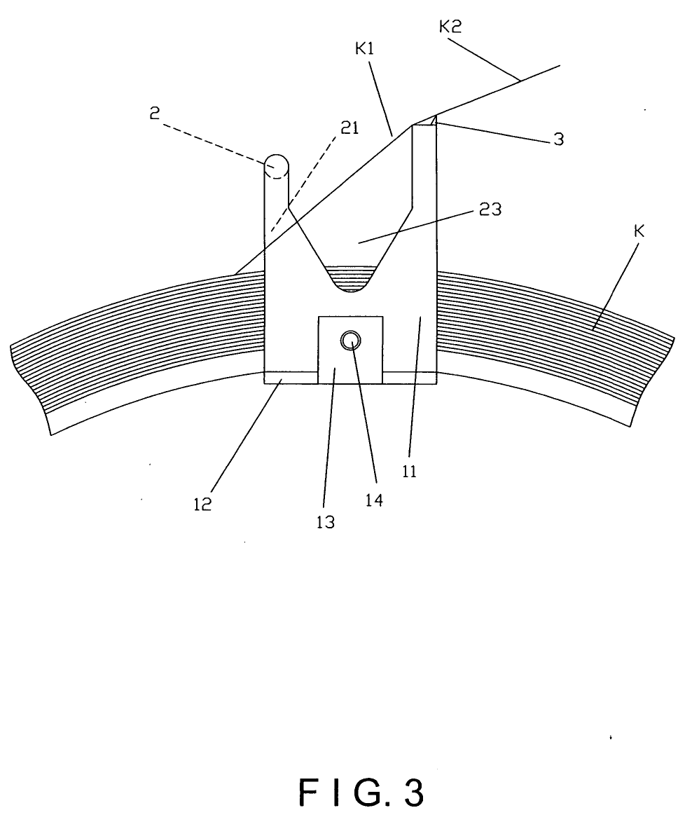

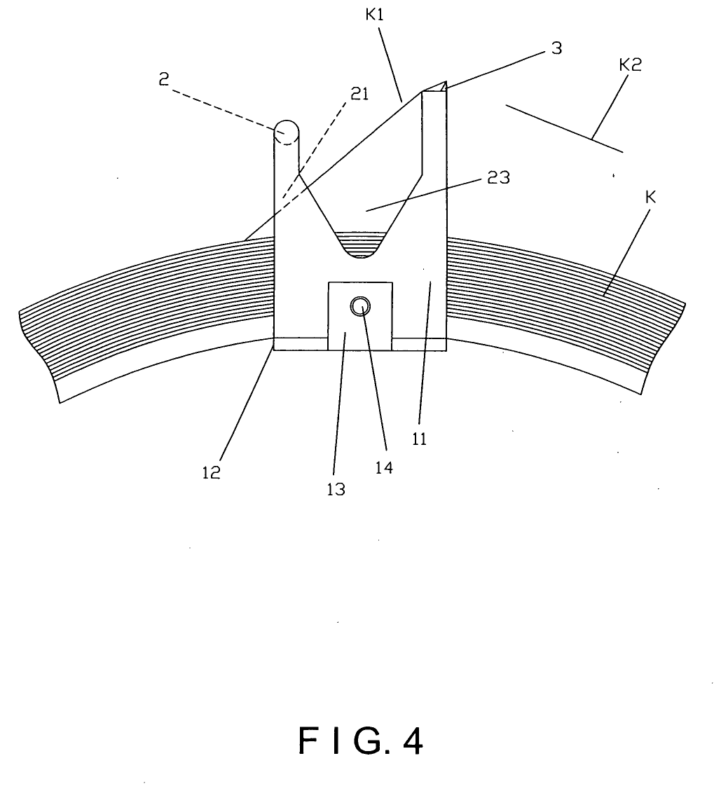

Referring to FIG. 2, in using the present invention, the movable member 12 is opened to put a tape roll K into the main seat 11, and then the first assembly part 13 of the movable member 12 is assembled with the first corresponding part 14 of the main seat 11 for fixing, such that the main seat 11 and the movable member 12 can be loosely sheathed on the tape roll K. After that, a free end K1 of the tape roll K is passed through the first space 21 of the dragging member 2 and is reeved back to the dragging member 2. Therefore, when pulling the free end K1 of tape, the main seat 11 and the movable member 12 will be dragged to move on the tape roll K at the same time. When the free end K1 is pulled to a proper length (as shown in FIG. 3), the free end K1 is abutted on the cutting edge 2 in an opposite direction, and is pulled down. At this time, a bottom of the movable member 12 is supported by fingers of an operator (the status of fingers is not shown in the drawing), to maintain a status of lifting up the free end K1, thereby cutting the free end K1 to form a cutting section K2 for use (as shown in FIG. 4). The free end K1 left behind will be crossed over on the cutting edge 3 from the tape roll K, such that in a next operation, it can be easily to put in the fingers from the second space 23 at two side rims of the main seat 11 to easily grip the residual free end K1.

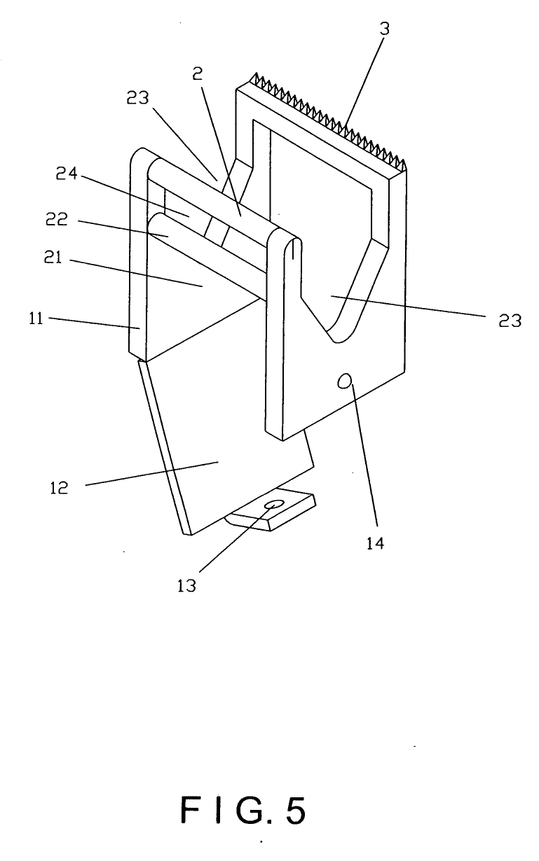

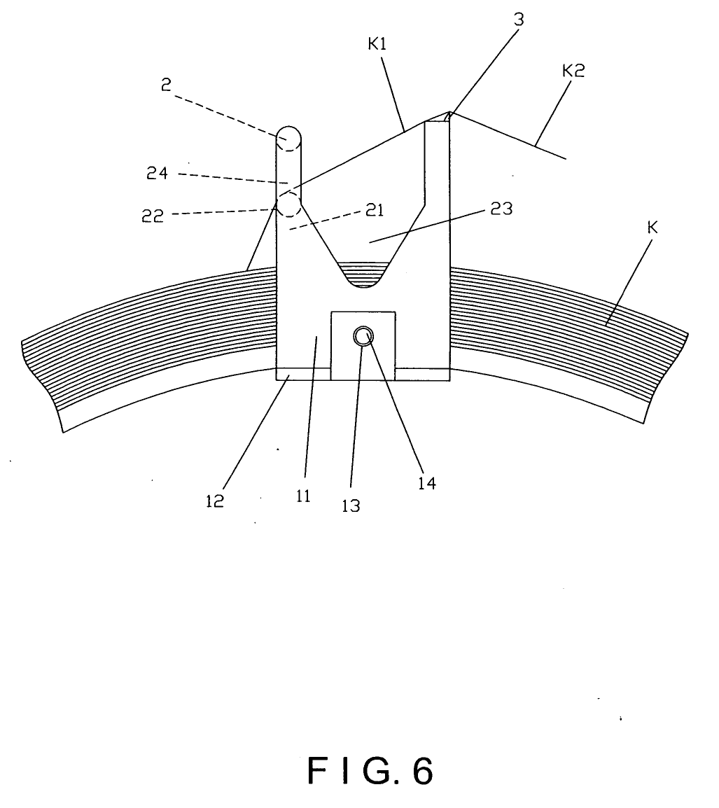

Referring to FIG. 5 and FIG. 6, the main seat 11 and the movable member 12 are interconnected through the first assembly part 13 and the first corresponding part 14, and the dragging member 2 and the cutting edge 3 are located at top of the main seat 11, wherein the dragging member 2 is transversally connected to the top of main seat 11 and a supporting member 22 is transversally located below the dragging member 2. The supporting member 22 is positioned into the first space 21, and a clearance 24 is preserved between the supporting member 22 and the dragging member 2 for allowing the tape to be passed into. The supporting member 22 can be a rod, a plate, and a lump. After cutting off the tape, the residual free end K1 will be crossed over on the cutting edge 3 through the supporting member 22. With the second space 23 at two side rims of the main seat 11, it can be more convenient to use the fingers to access the free end K1 of tape.

The aforementioned second space 21 at two side rims of the main seat 11 is better to be a little larger than the size of finger.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A tape dispenser comprising a main seat and a movable member;
the movable member being connected to the main seat and being able to move relatively to the main seat; a dragging member being located at a top of the main seat and a cutting edge being transversally located at a proper distance to the dragging member;
The dragging member is transversally crossed over on an upper rim of the main seat, a first space is formed below the dragging member, and a second space, which is not reaching to a bottom rim of the main seat, is formed from top to bottom at two side rims of the main seat, between the dragging member and the cutting edge.

2. The tape dispenser according to claim 1, wherein a supporting member is installed in the first space below the dragging member; the supporting member being positioned into the first space and a clearance being preserved between the supporting member and the dragging member.
